(19) United States
(12) Patent Application Publication
(10) Pub. No.: US 2025/0317480 A1
(43) Pub. Date: Oct. 9, 2025

(54) METHODS AND APPARATUS FOR SESSION MANAGEMENT FOR SWITCHING BETWEEN MULTI-SESSION PROTOCOLS AND ACCESS NETWORKS

(71) Applicant: CABLE TELEVISION LABORATORIES, INC., Louisville, CO (US)

(72) Inventor: Omkar Shripad Dharmadhikari, Lakewood, CO (US)

(21) Appl. No.: 19/172,188

(22) Filed: Apr. 7, 2025

Related U.S. Application Data
(60) Provisional application No. 63/575,376, filed on Apr. 5, 2024.

(51) Int. Cl. H04L 65/1069; H04W 76/12; H04W 84/04

(52) U.S. Cl. CPC H04L 65/1069; H04W 76/12; H04W 84/042

(57) ABSTRACT

Methods and apparatus for session management for a DualSteer device are provided herein. In some implementations, a method may include receiving a session establishment request from a UE registered in a first PLMN and connected to a first 3GPP access network and a non-3GPP access network simultaneously. In addition, the method may include sending, from the first PLMN, a PDU session create request to a second PLMN. The method may include creating, at the second PLMN a MA PDU policy association establishment session in response to the PDU session create request, the MA PDU policy association establishment session based on configured rules for accessing two 3GPP access networks simultaneously. The method may include sending, from the second PLMN, a PDU session create response to the first PLMN. Also, the method may include sending, from the first PLMN to the UE, a PDU session request and a reconfiguration message.

### CROSS-REFERENCE TO RELATED APPLICATIONS

This application claims the benefit of U.S. Provisional Application No. 63/575,376, filed Apr. 5, 2024, the contents of which are incorporated herein by reference.

### BACKGROUND

A multi-access-protocol data unit (MA PDU) session is a PDU session associated with two independent tunnels between a PDU session anchor (PSA) and an access node (AN) of a radio access network (RAN), and with multiple access types. For example, the MA PDU may be associated with a Third Generation Partnership Project (3GPP) access type and a non-3GPP access type with both access types connected to the Fifth Generation (5G) Core (5GC). The traffic of an MA PDU session may be transferred over a 3GPP access type, over a non-3GPP access type, or over two distinct 3GPP access types. Transfer over two distinct 3GPP access types may, for example, be over home network and a visited network.

MA PDU is a key enabler of access switching, whether switching between a 3GPP access and non-3GPP access or switching between two distinct 3GPP access types. Solutions for switching between 3GPP access and non-3GPP access currently exist. For example, switching between 3GPP access and non-3GPP access may be implemented using Access Traffic Steering, Switching and Splitting (ATSSS). More recent solutions for switching between two distinct 3GPP access types have been introduced, for example using a DualSteer feature. Currently, however, no solutions exists for switching between a 3GPP access type/non-3GPP access type, a dual 3GPP access type. Thus, the need exists for a solution to switch between each combination of access types.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving a session establishment request from an user equipment (UE) registered in a first public land mobile network (PLMN) and connected to a first 3GPP access network and a non-3GPP access network simultaneously. The method may also include sending, from the first PLMN, a PDU session create request to a second PLMN. The method may furthermore include creating, at the second PLMN, a multi-access-protocol data unit (MA PDU) policy association establishment session in response to the PDU session create request, the MA PDU policy association establishment session based on configured rules for accessing two 3GPP access networks simultaneously. The method may in addition include sending, from the second PLMN, a PDU session create response to the first PLMN. The method may moreover include sending, from the first PLMN to the UE, a PDU session request. The method may also include sending, from the first PLMN to the UE, a reconfiguration message. Other embodiments of this aspect include corresponding computer systems, apparatus, and computer programs recorded on one or more computer storage devices, each configured to perform the actions of the methods.

Implementations may include one or more of the following features. The method where the session establishment request may include information indicating a request to switch access from the non-3GPP access network to a second 3GPP access network for simultaneous connection with the first 3GPP access network and the second 3GPP access network. The method where the session establishment request is a PDU session establishment request message having a PDU session ID, a DualSteer capability indication, and a DualSteer MA PDU session request. The method where the first 3GPP access network and the non-3GPP access network are over the first PLMN. The method where the PDU session create request is a PDU session create message having a PDU session ID, a DualSteer capability indication, and a DualSteer MA PDU session request. The method where the PDU session create response may include a PDU session ID and a DualSteer MA PDU session response. The method where the PDU session create request may include a PDU session ID, a DualSteer MA PDU session allowed message, and DualSteer traffic rules. The method where the reconfiguration message is a radio resource control (RRC) reconfiguration message, and where the RRC reconfiguration message may include the PDU session ID, the DualSteer MA PDU session allowed message, and the DualSteer traffic rules. The method where the first 3GPP access network is over one of the first PLMN or the second PLMN, the non-3GPP access network is over a different one of the first PLMN or the second PLMN, and the session establishment request may include information indicating a request to switch access from over the non-3GPP access network to a second a 3GPP access network over a third PLMN for simultaneous connection with the first 3GPP access network. Implementations of the described techniques may include hardware, a method or process, or a computer tangible medium.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example user device;

FIG. 2 illustrates an example communication system;

FIG. 3 illustrates an example of a functional split between a next generation radio access network (NG-RAN) and Fifth Generation (5G) core (5GC);

FIG. 4 illustrates an example of a protocol stack for a user plane and a control plane;

FIG. 5 illustrates an example of the architecture for the case of a 5G-residential gateway (RG) connecting to the 5GC;

FIG. 6 illustrates an example of the architecture for a communication system capable of Access Traffic Steering, Switching and Splitting (ATSSS) and multi-subscriber identity module (MUSIM) communication;

FIG. 7 illustrates an example of the architecture for a communication system capable of ATSSS and MUSIM communication with a terrestrial network (TN) operator leveraging a non-TN (NTN) of a partner;

FIG. 8 illustrates an example of the architecture for a communication system capable of ATSSS and MUSIM communication with an NTN operator leveraging a TN of a partner;

FIG. 9 illustrates an example of the architecture for a communication system capable of ATSSS and MUSIM communication with an NTN operator leveraging an NTN of a partner;

FIG. 10 illustrates an example of the architecture for a communication system capable of ATSSS and MUSIM communication applicable to a non-public network (NPN);

FIG. 11A illustrates an example of the architecture for a communication system supporting multi-access-protocol data unit (MA PDU) session across a visited public land mobile network (VPLMN) with 3GPP access and a home public land mobile network (HPLMN) with 3GPP access and non3GPP access;

FIG. 11B illustrates an example of the architecture for a communication system supporting MA PDU session across a VPLMN with 3GPP access and non3GPP access and a HPLMN with 3GPP access;

FIG. 11C illustrates an example of the architecture for a communication system supporting MA PDU session across multiple VPLMNs with 3GPP access and a HPLMN with 3GPP access and non-3GPP access;

FIG. 11D illustrates an example of the architecture for a communication system supporting MA PDU session across a HPLMN with 3GPP access, a VPLMN with 3GPP access and a VPLMN with 3GPP access and non3-GPP access;

FIG. 12 illustrates an example of a MA PDU session management procedure with an HPLMN and a VPLMN; and

FIG. 13 is flow diagram of an example process for switching between simultaneous access over a 3GPP access network and non-3GPP access network, and simultaneous access over two 3GPP access networks.

### DETAILED DESCRIPTION

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A User Equipment (UE) may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

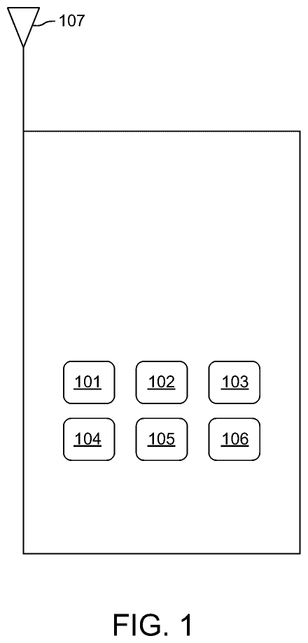

FIG. 1 is an illustration of an example device. In one case, the device may be a UE suited for mobile operation. In this example, the UE may have a processor 101, one or more transceivers 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous, for example, different timing/spacing for uplink (UL) or downlink (DL).

Different radio access technologies may be used with one or more transceivers (e.g., 802.11, WCDMA, CDMA2000, GSM, LTE, LTE-A, LTE-A Pro, NR etc.). The one or more transceivers may be co-located in a single unit, for example transceiver 102 as illustrated in FIG. 1. Although not illustrated in FIG. 1, it should be understood the device may have more than one transceiver.

For ease of description, switching between a 3GPP access type and a non-3GPP access type may be referred to as Access Traffic Steering, Switching and Splitting (ATSSS), and switching between a first 3GPP access and a second 3GPP access may be referred to as DualSteer. It is noted, however, that terms ATSSS and DualSteer should not be viewed as limiting in any manner.

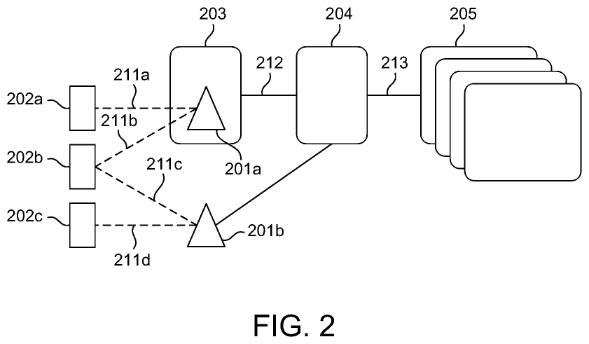

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points), and each base station may be part of a different public land mobile network (PLMN), for example a home PLMN and a visited PLMN.

Generally, a communication system may use a combination of wired and wireless connections at different points in the system. One or more wireless technologies may (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network (CN) 204, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same radio access technology (RAT) as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMFs, one or more UPFs, one or more Session Management Functions (SMFs), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

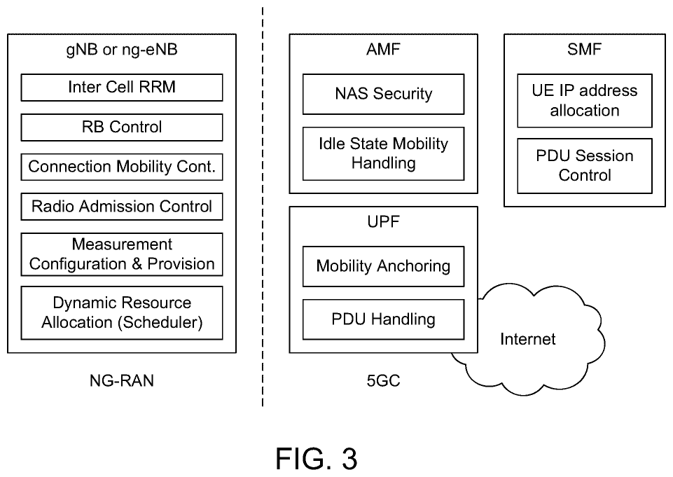

FIG. 3 illustrates an example of a functional split between the next generation radio access network (NG-RAN) and Fifth Generation (5G) core (5GC). The AMF may be connected to one or more gNB the RAN via an N2 interface and may serve as a control node. For example, the AMF may be responsible for authenticating a UE's support for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

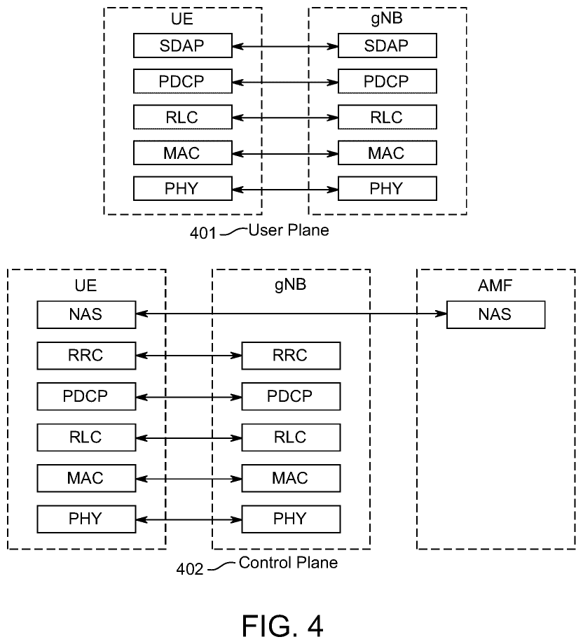

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: NAS, Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

The examples provided herein are based on the Third Generation Partnership Project (3GPP) 5G architecture and the procedures associated with the 5GC. One with ordinary skills in the art may envision other technologies being used and the same concepts may apply. Examples of other technologies may be 4G, CBRS, cdma2000, 6G, and beyond. The examples provided herein should not limit the scope of the methods.

The 3GPP standards support the access to the 5GC via a wireline access network (AN). A wireline 5G access network (W-5GAN) is a wireline AN that may connect to a 5GC. For example, devices in a home local access network (LAN), such as a residential gateway (RG), may connect to the 5GC via a Wireline Access Gateway Function (W-AGF) in the W-5GAN. The W-AGF is a network function that may interface with the 5GC Control Plane (CP) and the 5GC User Plane (UP) functions, via N2 and N3 interfaces, respectively. In the example of a home LAN, the W-AGF may provide connectivity towards the 5GC to the home LAN devices using one or more N2 and N3 interfaces with the 5GC.

A residential gateway (RG) is a device providing, for example, voice, data, broadcast video, video on demand, etc. to other devices in specific locations referred to as customer premises. In this example, an RG may have one or more processors, such as Central Processing Units (CPUs), Graphical Process Units (GPUs), Front End Processors (FEPs), Communication Processors (CPs), Field Programmable Gate Arrays (FPGAs), Vision Processing Units (VPU), Quantum Processing Units (QPUs), Associative Processing Units (APUs), and Tensor Processing Units (TPUs); a baseband radio; one or more transceivers; one or more antennas; storage, such as HDD, SSD, NVM, RAM, ROM, memory, cache; memory controller(s), a touchscreen, and a power source. The RG may also have one or more of its functions virtualized.

An RG may contain functionality that enables devices behind it to also connect with the 5GC and obtain 5G services. The devices behind the RG may be of different types, such as 3GPP-capable devices (e.g., UEs), authenticable non-3GPP (AUN3) devices, non-authenticable non-3GPP (NAUN3) devices, or non-5G-Capable over WLAN (N5CW) devices. An RG may be 5G-capable, in which case it is referred to as a 5G-RG, or it may be non-3GPP capable, in which case it is referred to as a Fixed Network RG (FN-RG). The 5G-RG may play the role of a UE.

While reference to 5GC is mentioned to assist in explaining the concepts of this invention, the examples and techniques discussed herein are equally applicable to other generations of wireless technologies, and may interchangeable with 3G, 4G, 6G, etc.

There are benefits to both users and operators to allow RGs, and devices that are non-3GPP capable and are behind RGs, to access the 3GPP 5G 5GC. The 5GC provides several features that may be beneficial, independent of the type of access technology used by the devices accessing the network. Users may receive the benefits of the rich 5G features, and operators may have means to charge for the usage of such features.

As an example, there may be one or more procedures that enable access to the Evolved Packet Core (EPC) or the 5GC via non-3GPP RATs. One such example is a UE accessing the 5GC using WLAN.

Additionally, there may be one or more procedures for supporting access to the 5GC via a wireline AN. As an example, a home LAN may be connected to the 5GC via an RG. The RG may contain functionality that enables devices behind it to connect with the 5GC and obtain 5G services.

The 5G-RG and the W-AGF may interface with the 5GC Control Plane (CP) and the 5GC User Plane (UP) functions, via N2 and N3 interfaces, respectively. They may enable authentication, registration and packet data network (PDN) connectivity procedures associated with the devices behind the RG. They may facilitate the provisioning of differentiated services to the devices behind the RG, via the interfaces with the 5GC.

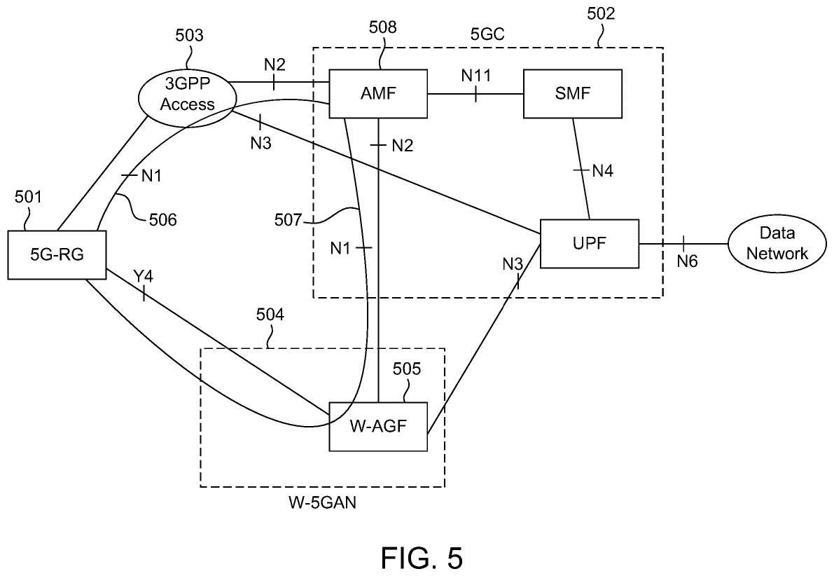

FIG. 5 illustrates an example of the architecture for the case of a 5G-RG connecting to the 5GC. As shown in an example in FIG. 5, there may be a 5G-RG 501 connecting to the 5GC (502, shown in dotted line in FIG. 5). As mentioned before, the 5G-RG 501 may be a 3GPP capable, and accordingly, it may connect to the 5GC 502 via a 3GPP access 503. An N1 link 506 may be established, via the 3GPP access 503 between the 5G-RG 501 and the 5GC 502.

At the same time, the 5G-RG 501 may connect to the 5GC 502 via a wireline access network W-5GAN (504, shown in dotted line in FIG. 5), using the W-AGF 505 functionality to interface with the 5GC 502. An N1 link 507 may be established between the 5GC 502 and the 5G-RG 501, which may transverse, transparently, through the W-AGF 507.

In the example in FIG. 5, multiple (e.g., 2) N1 links (e.g., N1 instances, N1 interfaces, N1 connections) 506, 507 may exist between the 5G-RG 501 and the 5GC 502, e.g., there may be one N1 link 506 via the 3GPP access 503 and one N1 link 507 via the W-5GAN 504. The 5G-RG 501 may be connected to a single 5GC 502, and a single AMF 508 may be connected and servicing the 5G-RG 501. The N1 link 507 between the 5G-RG 501 and the 5GC/AMF 502 may be an end-to-end link; e.g., the termination points are the 5G-RG 501 and the 5GC 502. The 5G-RG 501 supports NAS procedures and may behave as a UE. The NAS messages between the 5G-RG 501 and the 5GC 502 may be sent from the 5G-RG 501 to the W-AGF 505 via the W-CP signaling connection. The W-AGF 505 may transparently forward the message to the AMF 508. The W-AGF 505 may use an N2 Uplink NAS Transport message to forward the NAS message.

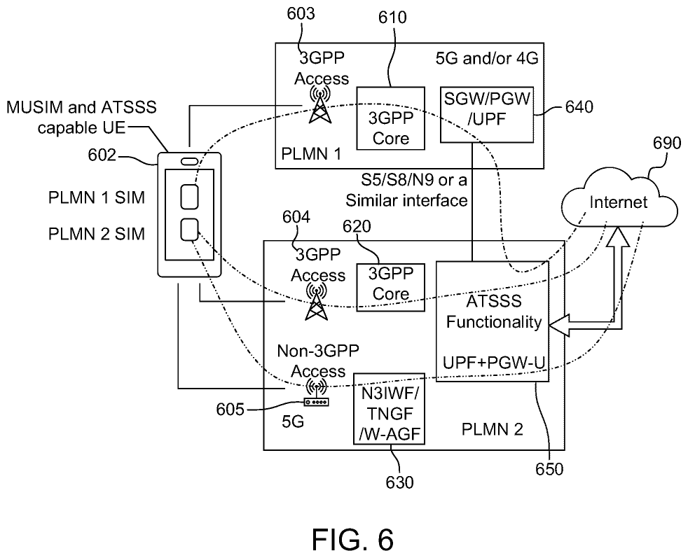

FIG. 6 illustrates an example of the architecture for a communication system capable of Access Traffic Steering, Switching and Splitting (ATSSS) and multi-subscriber identity module (MUSIM) communication. A Subscription Permanent Identifier (SUPI), which is globally unique identifier for each subscriber or UE may be contained in the MUSIM. As shown in an example in FIG. 6, a UE 602 may connect to a first public land mobile network (PLMN), such as PLMN 1, and may connect to a second PLMN, such as PLMN 2. The UE 602 may be MUSIM and ATSSS capable, and may contain a PLMN 1 subscriber identity module (SIM) and a PLMN 2 SIM. The UE 602 may be 3GPP capable, and use the PLMN 1 SIM to access the 3GPP Core 610, via 3GPP access 603, and the serving gateway (SGW)/PDN gateway (PGW)/UPF 640 in the PLMN 1. The PLMN 1 may be 5G capable, 4G capable, or both.

Further, the UE 602 may use the PLMN 2 SIM to access the 3GPP Core 620, via 3GPP access 604, and the UPF+PGW-U 650 in the PLMN 2. The UPF+PGW-U 650 may include ATSSS functionality. The UE may further may use the PLMN 2 SIM to access the Non-3GPP Interworking Function (N3IWF)/Trust Non-3GPP (TNGF)/W-AGF 630, via Non-3GPP access 605, and the UPF+PGW-U 650 in the PLMN 2. The PLMN 2 may be 5G capable.

Further, data sessions across both SIMs are anchored using the UPF+PGW-U 650 in the PLMN 2, which may be the anchor network. Accordingly, the UE 602 may access the internet 690 using the PLMN 2 SIM and the UPF+PGW-U 650 in the PLMN 2, via either the 3GPP Access 604 or the non-3GPP Access 605, or via both. Additionally or alternatively, the UE 602 may further access the internet 690 using the PLMN 1 SIM and the UPF+PGW-U 650 by way of the SGW/PGW/UPF 640. Additionally or alternatively, the UPF+PGW-U 650 and the SGW/PGW/UPF 640 may be linked by an S5/S8/N9 or similar interface.

Steering, switching and splitting can be performed across SIMs camped on the same PLMN. Additionally or alternatively, steering, switching and splitting can be performed across SIMs camped on different PLMNs. Moreover, the different PLMNs may be deployed by the same or different operators. Additionally or alternatively, a PLMN may be a terrestrial network (TN) or a non-TN (NTN). Additionally or alternatively, a PLMN may be a public network or a private network. Moreover, if the PLMNs belong to different operators, an administrative relationship may exist between the two PLMNs, such as PLMN 1 and PLMN 2.

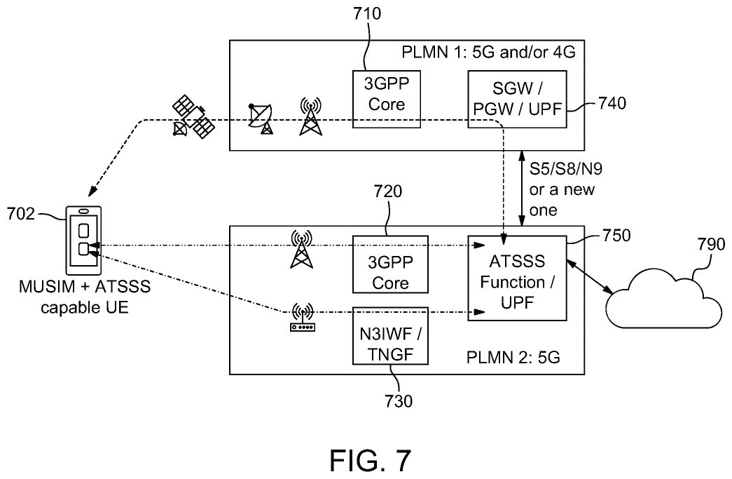

FIG. 7 illustrates an example of the architecture for a communication system capable of ATSSS and MUSIM communication with a TN operator leveraging an NTN of a partner. As shown in an example in FIG. 7, a UE 702 may connect to an NTN PLMN 1 and may connect to a TN PLMN 2. The UE 702 may be MUSIM and ATSSS capable. The UE 702 may access the 3GPP Core 710, via 3GPP access, and the SGW/PGW/UPF 740 in the PLMN 1. The PLMN 1 may be 5G capable, 4G capable, or both.

Further, the UE 702 may access the 3GPP Core 720, via 3GPP access, and then the ATSSS Function/UPF 750 in the PLMN 2. The UE may further may access the N3IWF/TNGF 730, via non-3GPP access, and then the ATSSS Function/UPF 750 in the PLMN 2. The PLMN 2 may be 5G capable.

Also, the UE 702 may access the internet 790 using the ATSSS Function/UPF 750 in the PLMN 2, via either the 3GPP Access or the non-3GPP Access, or via both. Additionally or alternatively, the UE 702 may further access the internet 790 using the PLMN 1 and the ATSSS Function/UPF 750 by way of the SGW/PGW/UPF 740. Additionally or alternatively, the ATSSS Function/UPF 750 and the SGW/PGW/UPF 740 may be linked by an S5/S8/N9 or similar interface, or a new interface.

Moreover, steering, switching and splitting can be performed across NTNs and TNs operated by the same or different operators. Additionally or alternatively, whether PLMN 1 and PLMN 2 belong to the same or different operators may be dependent on a business agreement and enabling of an S5/S8/N9 interface.

An example shown in FIG. 7 provides flexibility to home operators in terms of switching, steering, or splitting, between the PLMN 1 and PLMN 2. Further, this example avoids the complexity associated with seamless mobility across the two networks.

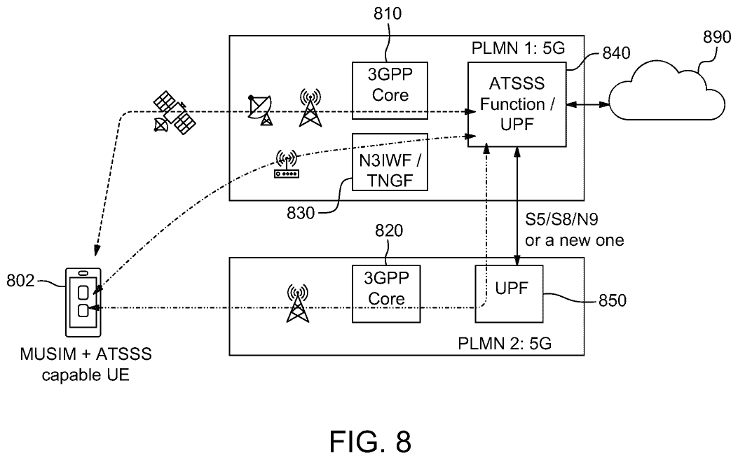

FIG. 8 illustrates an example of the architecture for a communication system capable of ATSSS and MUSIM communication with an NTN operator leveraging a TN of a partner. As shown in an example in FIG. 8, a UE 802 may connect to an NTN PLMN 1 and may connect to a TN PLMN 2. The UE 802 may be MUSIM and ATSSS capable. The PLMN 1 may be 5G capable. The UE 802 may access the 3GPP Core 810, via 3GPP access, and then the ATSSS Function/UPF 840 in the PLMN 1. The UE may further may access the N3IWF/TNGF 830, via non-3GPP access, and then the ATSSS Function/UPF 840 in the PLMN 1. The PLMN 1 may be 5G capable.

Further, the UE 802 may access the 3GPP Core 820, via 3GPP access, and the UPF 850 in the PLMN 2. The PLMN 2 may be 5G capable.

Moreover, the UE 802 may access the internet 890 using the ATSSS Function/UPF 840 in the PLMN 1, via either the 3GPP Access or the non-3GPP Access, or via both. Additionally or alternatively, the UE 802 may further access the internet 890 using the PLMN 2 and the ATSSS Function/UPF 840 by way of the UPF 850. Additionally or alternatively, the ATSSS Function/UPF 840 and the UPF 850 may be linked by an S5/S8/N9 or similar interface, or a new interface.

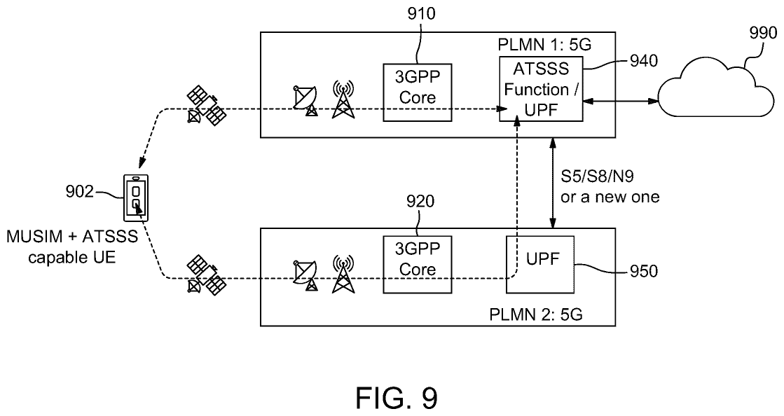

FIG. 9 illustrates an example of the architecture for a communication system capable of ATSSS and MUSIM communication with an NTN operator leveraging an NTN of a partner. As shown in an example in FIG. 9, a UE 902 may connect to an NTN PLMN 1 and may connect to an NTN PLMN 2. The UE 902 may be MUSIM and ATSSS capable. The PLMN 1 may be 5G capable and the PLMN 2 may be 5G capable. The UE 902 may access the 3GPP Core 910, via 3GPP access, and then the ATSSS Function/UPF 940 in the PLMN 1. Further, the UE 902 may access the 3GPP Core 920, via 3GPP access, and the UPF 950 in the PLMN 2.

Moreover, the UE 902 may access the internet 990 using the ATSSS Function/UPF 940 in the PLMN 1. Additionally or alternatively, the UE 802 may further access the internet 990 using the PLMN 2 and the ATSSS Function/UPF 940 by way of the UPF 950. Additionally or alternatively, the ATSSS Function/UPF 940 and the UPF 950 may be linked by an S5/S8/N9 or similar interface, or a new interface.

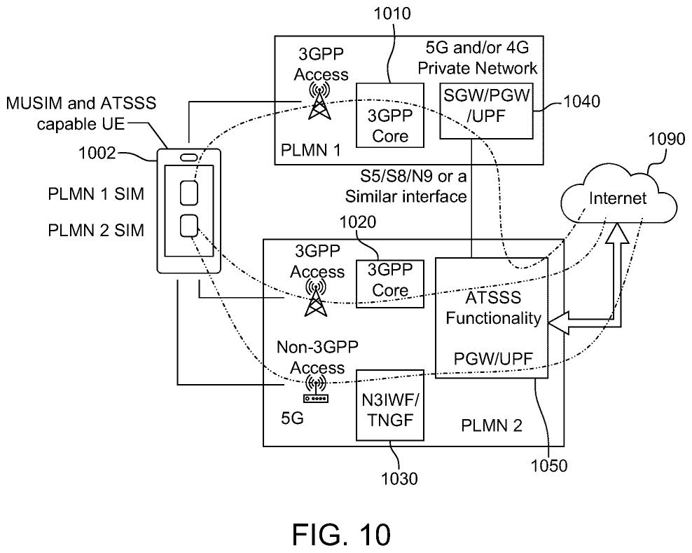

FIG. 10 illustrates an example of the architecture for a communication system capable of ATSSS and MUSIM communication applicable to a non-public network (NPN). As shown in an example in FIG. 10, a UE 1002 may connect to a PLMN 1 and to a PLMN 2. The UE 1002 may be MUSIM and ATSSS capable, and may contain a PLMN 1 SIM and a PLMN 2 SIM. The UE 1002 may be 3GPP capable, and use the PLMN 1 SIM to access the 3GPP Core 1010, via 3GPP access, and the SGW/PGW/UPF 1040 in the PLMN 1. The PLMN 1 may be 5G capable, 4G capable, or both. Further, the PLMN 1 may be a private network.

Further, the UE 1002 may use the PLMN 2 SIM to access the 3GPP Core 1020, via 3GPP access, and the PGW/UPF 1050 in the PLMN 2. The PGW/UPF 1050 may include ATSSS functionality. The UE 1002 may further may use the PLMN 2 SIM to access the N3IWF/TNGF 1030, via Non-3GPP access, and the PGW/UPF 1050 in the PLMN 2. The PLMN 2 may be 5G capable.

Moreover, the UE 1002 may access the internet 1090 using the PLMN 2 SIM and the PGW/UPF 1050 in the PLMN 2, via either the 3GPP Access or the non-3GPP Access, or via both. Additionally or alternatively, the UE 1002 may further access the internet 1090 using the PLMN 1 SIM and the PGW/UPF 1050 by way of the SGW/PGW/UPF 1040. Additionally or alternatively, the PGW/UPF 1050 and the SGW/PGW/UPF 1040 may be linked by an S5/S8/N9 or similar interface. Accordingly, this connectivity facilitates enhanced user experience for users of the private network.

MA PDU is a key enabler of Access Traffic Steering, Switching and Splitting (ATSSS). An ATSSS-capable user equipment (UE) may communicate over 3GPP access, over non-3GPP access, or over both accesses.

A DualSteer device is a device supporting traffic steering, switching and splitting of user data, for different services, across two 3GPP access networks. The traffic steering and switching of user data may be performed simultaneously or non-simultaneously over the two 3GPP networks. Traffic steering is a procedure that selects an access network and transfers traffic over the selected access network. DualSteer traffic steering occurs when traffic of one or multiple services/applications is sent across two 3GPP access networks, including scenarios where all services use the same network connection (no simultaneous data over the two networks) or different services are steered across different networks (with simultaneous data over the two networks). Traffic switching is a procedure that moves all traffic from one access network to another access network in a way that minimizes service interruption. DualSteer traffic switching occurs when traffic of one or multiple services/applications is moved from one 3GPP access network to another. Traffic splitting is a procedure that splits the traffic of a data flow across multiple access networks. When traffic splitting is applied to a data flow, some traffic of the data flow is transferred via one access and some other traffic of the same data flow is transferred via another access. DualSteer traffic splitting occurs when traffic of a single data flow belonging to a service/application is sent across two 3GPP access networks.

A DualSteer UE is an example of a DualSteer device. Additionally or alternatively, a DualSteer device may include two DualSteer UEs.

Embodiments and examples provided herein apply to two NR/5GC accesses in two different PLMNs (including two visited PLMNs (VPLMNs) or a VPLMN and the home PLMN (HPLMN)) with each access being NR TN or NR NTN. Further, embodiments and examples provided herein apply to both DualSteer UEs capable of non-simultaneous data transmission over the two networks, and DualSteer UEs capable of simultaneous data transmission over the two networks.

Also, embodiments and examples provided herein leverages MA PDU session procedures defined for ATSSS for DualSteer. The unmodified PDU Session Establishment Procedures follow the ones defined in 3GPP TS 23.502 clauses 4.3.2.2.1 and 4.3.2.2.2. The contents of 3GPP TS 23.502 are incorporated by reference, as if fully set forth herein. These procedures are modified in embodiments and examples provided herein by adding that the DualSteer UE sends a DualSteer capability indication to the network, and the network responds with a container information element (IE), specific for DualSteer or leveraging an ATSSS container, that includes the DualSteer parameters for the UE for traffic steering, traffic switching and traffic splitting.

Moreover, embodiments and examples provided herein has no impact to the registration procedure as defined in TS 23.502 clause 4.2.2.2.2, except for indicating the DualSteer support by the network within the Registration accept message indicating support for the DualSteer feature using the 5GS network feature support IE. Within this IE, the network should indicate whether it supports ATSSS, DualSteer or both. If the network supports both, it should also indicate what the network prefers—ATSSS or DualSteer. The individual registrations across both the 3GPP access networks are independent, and the DualSteer policies and rules are applied considering network availability. Further, the contents of TR 23.700-54 are incorporated by reference, as if fully set forth herein.

An example session management solution for DualSteer using MA PDU procedures is provided herein. The example solution leverages the MA PDU session, currently defined for ATSSS, as a PDU session that provides a PDU connectivity service, which can use one access network at a time, or simultaneously one 3GPP access network and one non-3GPP access network. The MA PDU session is extended to a PDU session that provides a PDU connectivity service, which can use one access network at a time, or simultaneously one 3GPP access network and one non-3GPP access network or simultaneously two 3GPP access networks.

In the case of DualSteer, an MA PDU session can be established when the UE is registered to the same PLMN over the two 3GPP access networks or registered to different PLMNs over the two 3GPP access networks. A UE can initiate MA PDU session establishment when the UE is registered to a PLMN over either of the 3GPP access networks. Therefore, at any given time, the MA PDU session can have user-plane resources established on both 3GPP access networks, or on a single 3GPP access only.

Activating multi-access PDU connectivity service for DualSteer refers to the establishment of user-plane resources on two 3GPP accesses. If the UE is registered over both 3GPP access networks in the same PLMN, the UE initiates the UE-requested PDU session establishment procedure over a selected access. Over which access to initiate this UE-requested PDU session establishment procedure is UE implementation specific.

If the UE is registered over both 3GPP access networks in different PLMNs, the UE initiates the UE-requested PDU session establishment procedure over each 3GPP access sequentially. Over which access to first initiate the UE-requested PDU session establishment procedure is UE implementation specific.

If the UE is registered to a PLMN over only one access, either 3GPP access, the UE initiates the UE-requested PDU session establishment procedure over this access. When the UE at a later point in time registers over the other 3GPP access, either in the same PLMN or in a different PLMN, it initiates the UE-requested PDU session establishment procedure with the same PDU session identifier (ID) over the other access in order to establish user plane resources on the other access for the MA PDU session.

Activating multi-access PDU connectivity service refers to the establishment of user-plane resources on both 3GPP accesses or one 3GPP access and one non-3GPP access.

In an example, When a UE is registered over both 3GPP access networks and the non-3GPP in the same PLMN, the UE may decide whether to initiate the MA PDU Session Establishment procedure over two 3GPP access networks (for DualSteer) or initiate the MA PDU Session Establishment procedure over a 3GPP access network and a non-3GPP access network based on the operator defined preference.

If the UE decides to prioritize MA PDU Session Establishment procedure across two 3GPP access networks (DualSteer) over MA PDU Session Establishment procedure across a 3GPP access network and a non-3GPP access network (ATSSS), then the UE may initiate the UE requested PDU session establishment procedure as specified in clause 6.4.1.2 of 3GPP TS 24.501 over the selected 3GPP access.

When the UE receives the PDU SESSION ESTABLISHMENT ACCEPT message including the DualSteer container IE, the UE may consider that the MA PDU session has been established and the user plane resources are successfully established on the selected access. When the user plane resources are established on the access other than the selected access, the UE shall consider the user plane resources are established on both.

It is noted that if the UE receives the PDU SESSION ESTABLISHMENT ACCEPT message including the DualSteer container IE and fails to receive user plane resources established on the access other than the selected access, upon an implementation specific timer expiry the UE may reinitiate the UE requested PDU session establishment procedure over the access other than the selected access, in order to establish user plane resources on the access other than the selected access.

If the UE decides to prioritize a MA PDU Session Establishment procedure across a 3GPP access network and a non-3GPP access network (ATSSS) over a MA PDU Session Establishment procedure over two 3GPP access networks (DualSteer), then the UE may initiate the UE requested PDU session establishment procedure as specified in clause 6.4.1.2 of 3GPP TS 24.501 over the selected access (either the 3GPP access or the non-3GPP access).

When the UE receives the PDU SESSION ESTABLISHMENT ACCEPT message including the ATSSS container IE, the UE may consider that the MA PDU session has been established and the user plane resources are successfully established on the selected access. When the user plane resources are established on the access other than the selected access, the UE may consider the user plane resources are established on both.

It is noted that if the UE receives the PDU SESSION ESTABLISHMENT ACCEPT message including the ATSSS container IE and fails to receive user plane resources established on the access other than the selected access, upon an implementation specific timer expiry the UE may reinitiates the UE requested PDU session establishment procedure over the access other than the selected access in order to establish user plane resources on the access other than the selected access.

In another, if the UE is registered over both 3GPP access networks in the same PLMN but registered to the non-3GPP in a different PLMN, the UE may decide whether to initiate the MA PDU Session Establishment procedure over two 3GPP access networks (for DualSteer) or initiate the MA PDU Session Establishment procedure over a 3GPP access network and a non-3GPP access network (ATSSS) based on the operator defined preference.

If the UE decides to prioritize a MA PDU Session Establishment procedure across two 3GPP access networks (DualSteer) over MA PDU Session Establishment procedure across a 3GPP access network and a non-3GPP access network (ATSSS), then the UE may initiate the UE-requested PDU session establishment procedure as specified in clause 6.4.1.2 of 3GPP TS 24.501 over the selected 3GPP access.

When the UE receives the PDU SESSION ESTABLISHMENT ACCEPT message including the DualSteer container IE, the UE may consider that the MA PDU session has been established and the user plane resources are successfully established on the selected access. When the user plane resources are established on the access other than the selected access, the UE shall consider the user plane resources are established on both.

It is noted that when the UE receives the PDU SESSION ESTABLISHMENT ACCEPT message including the DualSteer container IE and fails to receive user plane resources established on the access other than the selected access, upon an implementation specific timer expiry the UE reinitiates the UE requested PDU session establishment procedure over the access other than the selected access, in order to establish user plane resources on the access other than the selected access.

If the UE decides to prioritize MA PDU Session Establishment procedure across a 3GPP access network and a non-3GPP access network (ATSSS) over the MA PDU Session Establishment procedure over two 3GPP access networks (DualSteer), then the UE may initiate UE-requested PDU session establishment procedure as specified in clause 6.4.1.2 of 3GPP TS 24.501 over 3GPP access and non-3GPP access sequentially. Over which access to first initiate the UE-requested PDU session establishment procedure is UE implementation specific.

When the UE receives the PDU SESSION ESTABLISHMENT ACCEPT message including the ATSSS container IE as specified in clause 6.4.1.3 of 3GPP TS 24.501 over the selected access, the UE may consider that the MA PDU session has been established and the user plane resources of the MA PDU session on this access are successfully established. The UE may then initiate the UE-requested PDU session establishment procedure with the same PDU session ID, as specified in clause 6.4.1.2 of 3GPP TS 24.501 over the other access, in order to establish user plane resources on the other access for the MA PDU session. If the UE receives the PDU SESSION ESTABLISHMENT ACCEPT message as specified in clause 6.4.1.3 of 3GPP TS 24.501 over the other access, the UE may consider that the user plane resources of the MA PDU session have been established on both 3GPP access and non-3GPP access.

In another, if the UE is registered over both 3GPP access networks in different PLMNs, but registered to the non-3GPP in the same PLMN as one of the 3GPP access network, the UE may decide whether to initiate the MA PDU Session Establishment procedure over two 3GPP access networks (for DualSteer) or initiate the MA PDU Session Establishment procedure over a 3GPP access network and a non-3GPP access network based on the operator defined preference.

If the UE decides to prioritize MA PDU Session Establishment procedure across two 3GPP access networks (DualSteer) over MA PDU Session Establishment procedure across a 3GPP access network and a non-3GPP access network (ATSSS), then the UE may initiate the UE requested PDU session establishment procedure as specified in clause 6.4.1.2 of 3GPP TS 24.501 over each 3GPP access sequentially. Over which access to first initiate the UE requested PDU session establishment procedure is UE implementation specific.

When the UE receives the PDU SESSION ESTABLISHMENT ACCEPT message including the DualSteer container IE over the selected access, the UE may consider that the MA PDU session has been established and the user plane resources of the MA PDU session on this access are successfully established. The UE may then initiate the UE requested PDU session establishment procedure with the same PDU session ID over the other access, in order to establish user plane resources on the other access for the MA PDU session. If the UE receives the PDU SESSION ESTABLISHMENT ACCEPT message over the other access, the UE may consider that the user plane resources of the MA PDU session have been established on both 3GPP access networks.

If the UE decides to prioritize MA PDU Session Establishment procedure across a 3GPP access network and a non-3GPP access network (ATSSS) over the MA PDU Session Establishment procedure over two 3GPP access networks (DualSteer), then the UE may initiate the UE-requested PDU session establishment procedure as specified in clause 6.4.1.2 of 3GPP TS 24.501 over the selected access (either the 3GPP access or the non-3GPP access).

When the UE receives the PDU SESSION ESTABLISHMENT ACCEPT message including the ATSSS container IE, the UE may consider that the MA PDU session has been established and the user plane resources are successfully established on the selected access. When the user plane resources are established on the access other than the selected access, the UE shall consider the user plane resources are established on both.

It is also noted here that if the UE receives the PDU SESSION ESTABLISHMENT ACCEPT message including the ATSSS container IE and fails to receive user plane resources established on the access other than the selected access, upon an implementation specific timer expiry the UE re initiates the UE requested PDU session establishment procedure over the access other than the selected access, in order to establish user plane resources on the access other than the selected access.

In another example, if the UE is registered over both 3GPP access networks and the non-3GPP in different PLMN, the UE may decide whether to initiate the MA PDU Session Establishment procedure over two 3GPP access networks (for DualSteer) or initiate the MA PDU Session Establishment procedure over a 3GPP access network and a non-3GPP access network based on the operator defined preference.

If the UE decides to prioritize MA PDU Session Establishment procedure across two 3GPP access networks (DualSteer) over MA PDU Session Establishment procedure across a 3GPP access network and a non-3GPP access network (ATSSS), then the UE may initiate the UE requested PDU session establishment procedure as specified in clause 6.4.1.2 of 3GPP TS 24.501 over each 3GPP access sequentially. Over which access to first initiate the UE requested PDU session establishment procedure is UE implementation specific.

When the UE receives the PDU SESSION ESTABLISHMENT ACCEPT message including the DualSteer container IE over the selected access, the UE may consider that the MA PDU session has been established and the user plane resources of the MA PDU session on this access are successfully established. The UE may then initiate the UE-requested PDU session establishment procedure with the same PDU session ID over the other access, in order to establish user plane resources on the other access for the MA PDU session. If the UE receives the PDU SESSION ESTABLISHMENT ACCEPT message over the other access, the UE shall consider that the user plane resources of the MA PDU session have been established on both 3GPP access networks.

If the UE decides to prioritize MA PDU Session Establishment procedure across a 3GPP access network and a non-3GPP access network (ATSSS) over the MA PDU Session Establishment procedure over two 3GPP access networks (DualSteer), then the UE may initiate UE-requested PDU session establishment procedure as specified in clause 6.4.1.2 of 3GPP TS 24.501 over 3GPP access and non-3GPP access sequentially. Over which access to first initiate the UE-requested PDU session establishment procedure is UE implementation specific.

When the UE receives the PDU SESSION ESTABLISHMENT ACCEPT message including the ATSSS container IE as specified in clause 6.4.1.3 of 3GPP TS 24.501 over the selected access, the UE may consider that the MA PDU session has been established and the user plane resources of the MA PDU session on this access are successfully established. The UE may then initiate the UE-requested PDU session establishment procedure with the same PDU session ID, as specified in clause 6.4.1.2 of 3GPP TS 24.501 over the other access, in order to establish user plane resources on the other access for the MA PDU session. If the UE receives the PDU SESSION ESTABLISHMENT ACCEPT message as specified in clause 6.4.1.3 of 3GPP TS 24.501 over the other access, the UE may consider that the user plane resources of the MA PDU session have been established on both 3GPP access and non-3GPP access.

In another example, if the UE is registered over both 3GPP access networks in the same PLMN and is not registered to a non-3GPP access in the same or different PLMN, regardless of whether the UE prioritizes ATSSS over DualSteer or vice versa, the UE may initiate the UE requested PDU session establishment procedure as specified in clause 6.4.1.2 of 3GPP TS 24.501 over a selected 3GPP access. Over which access to initiate this UE-requested PDU session establishment procedure is UE implementation specific.

When the UE receives the PDU SESSION ESTABLISHMENT ACCEPT message including the DualSteer container IE, the UE may consider that the MA PDU session has been established and the user plane resources are successfully established on the selected access. When the user plane resources are established on the access other than the selected access, the UE may consider the user plane resources are established on both.

If the UE prioritizes ATSSS over DualSteer, and when the UE at a later point in time registers over a non-3GPP access, either in the same PLMN or in a different PLMN, the UE may release the MA PDU session from one of the 3GPP access and initiate a PDU Session Establishment procedure with the same PDU session ID over the non-3GPP access in order to establish user plane resources for the MA PDU session.

If the UE prioritizes DualSteer over ATSSS, but loses connectivity to one of the 3GPP access, and is registered over non-3GPP access (prior or after losing the connectivity to one of the 3GPP access), either in the same PLMN or in a different PLMN, the UE may initiate a PDU Session Establishment procedure with the same PDU session ID over the non-3GPP access in order to establish user plane resources for the MA PDU session.

It is noted that if, the UE receives the PDU SESSION ESTABLISHMENT ACCEPT message including the DualSteer container IE and fails to receive user plane resources established on the access other than the selected access, upon an implementation specific timer expiry the UE reinitiates the UE requested PDU session establishment procedure over the access other than the selected access, in order to establish user plane resources on the access other than the selected access.

In another example, if the UE is registered over both 3GPP access networks in different PLMNs, for example a HPLMN and a VPLMN, and is not registered to a non-3GPP access in the same or different PLMN, regardless of whether the UE prioritizes ATSSS over DualSteer or vice versa, the UE may initiate the UE-requested PDU session establishment procedure as specified in clause 6.4.1.2 of 3GPP TS 24.501 over each 3GPP access sequentially. Over which access to first initiate the UE-requested PDU session establishment procedure is UE implementation specific.

When the UE receives the PDU SESSION ESTABLISHMENT ACCEPT message including the DualSteer container IE over the selected access, the UE shall consider that the MA PDU session has been established and the user plane resources of the MA PDU session on this access are successfully established. The UE may then initiate the UE-requested PDU session establishment procedure with the same PDU session ID over the other access, in order to establish user plane resources on the other access for the MA PDU session. If the UE receives the PDU SESSION ESTABLISHMENT ACCEPT message over the other access, the UE may consider that the user plane resources of the MA PDU session have been established on both 3GPP access networks.

If the UE prioritizes ATSSS over DualSteer, and when the UE at a later point in time registers over a non-3GPP access, either in the same PLMN or in a different PLMN, the UE may release the MA PDU session from one of the 3GPP access and initiate a PDU Session Establishment procedure with the same PDU session ID over the non-3GPP access in order to establish user plane resources for the MA PDU session.

If the UE prioritizes DualSteer over ATSSS, but loses connectivity to one of the 3GPP access, and is registered over non-3GPP access (prior or after losing the connectivity to one of the 3GPP access), either in the same PLMN or in a different PLMN, the UE may initiate a PDU Session Establishment procedure with the same PDU session ID over the non-3GPP access in order to establish user plane resources for the MA PDU session.

In another example, if the UE is registered over a single 3GPP access and non-3GPP access in the same PLMN, regardless of whether the UE prioritizes ATSSS over DualSteer or vice versa, the UE may initiate the UE requested PDU session establishment procedure as specified in clause 6.4.1.2 of 3GPP TS 24.501 over a selected access, either 3GPP access or non-3GPP access. Over which access to initiate this UE requested PDU session establishment procedure is UE implementation specific.

When the UE receives the PDU SESSION ESTABLISHMENT ACCEPT message including the ATSSS container IE as specified in clause 6.4.1.3 of 3GPP TS 24.501, the UE may consider that the MA PDU session has been established and the user plane resources are successfully established on the selected access. When the user plane resources are established on the access other than the selected access (e.g. received lower layer indication in 3GPP access or established user plane IPsec SA in untrusted non-3GPP access), the UE may consider the user plane resources are established on both.

Here it is also noted that if the UE receives the PDU SESSION ESTABLISHMENT ACCEPT message including the ATSSS container IE and fails to receive user plane resources established on the access other than the selected access, upon an implementation specific timer expiry the UE may reinitiate the UE requested PDU session establishment procedure over the access other than the selected access, in order to establish user plane resources on the access other than the selected access.

If the UE prioritizes DualSteer over ATSSS, and when the UE at a later point in time registers over another 3GPP access, either in the same PLMN or in a different PLMN, the UE may release the MA PDU session from the non-3GPP access and initiate a PDU Session Establishment procedure with the same PDU session ID over the other 3GPP access in order to establish user plane resources for the MA PDU session.

If the UE prioritizes ATSSS over DualSteer, but loses connectivity to the non-3GPP access, and is registered over another 3GPP access (prior or after losing the connectivity to the non-3GPP access), either in the same PLMN or in a different PLMN, the UE may initiate a PDU Session Establishment procedure with the same PDU session ID over the other 3GPP access in order to establish user plane resources for the MA PDU session.

In another example, if the UE is registered over a single 3GPP access and non-3GPP access in different PLMN, regardless of whether the UE prioritizes ATSSS over DualSteer or vice versa, the UE may initiate the UE-requested PDU session establishment procedure as specified in clause 6.4.1.2 of 3GPP TS 24.501 over 3GPP access and non-3GPP access sequentially. Over which access to first initiate the UE-requested PDU session establishment procedure is UE implementation specific.

When the UE receives the PDU SESSION ESTABLISHMENT ACCEPT message including the ATSSS container IE as specified in clause 6.4.1.3 of 3GPP TS 24.501 over the selected access, the UE shall consider that the MA PDU session has been established and the user plane resources of the MA PDU session on this access are successfully established. The UE may then initiate the UE-requested PDU session establishment procedure with the same PDU session ID, as specified in clause 6.4.1.2 of 3GPP TS 24.501 over the other access, in order to establish user plane resources on the other access for the MA PDU session. If the UE receives the PDU SESSION ESTABLISHMENT ACCEPT message as specified in clause 6.4.1.3 of 3GPP TS 24.501 over the other access, the UE may consider that the user plane resources of the MA PDU session have been established on both 3GPP access and non-3GPP access.

If the UE prioritizes DualSteer over ATSSS, and when the UE at a later point in time registers over another 3GPP access, either in the same PLMN or in a different PLMN, the UE may release the MA PDU session from the non-3GPP access and initiate a PDU Session Establishment procedure with the same PDU session ID over the other 3GPP access in order to establish user plane resources for the MA PDU session.

If the UE prioritizes ATSSS over DualSteer, but loses connectivity to the non-3GPP access, and is registered over another 3GPP access (prior or after losing the connectivity to the non-3GPP access), either in the same PLMN or in a different PLMN, the UE may initiate a PDU Session Establishment procedure with the same PDU session ID over the other 3GPP access in order to establish user plane resources for the MA PDU session.

In another example, if the UE is registered to a PLMN over only one access, either 3GPP access or a non-3GPP access, regardless of whether the UE prioritizes ATSSS over DualSteer or vice versa, the UE may initiate the UE-requested PDU session establishment procedure as specified in clause 6.4.1.2 of 3GPP TS 24.501 over this access. When the UE receives the PDU SESSION ESTABLISHMENT ACCEPT message including the ATSSS and DualSteer container IE over the access, the UE may consider that the MA PDU session has been established and the user plane resources of the MA PDU session on this access are successfully established.

If the UE performs the initial registration on one of the 3GPP access, and when the UE at a later point in time registers over another 3GPP access or a non-3GPP access either in the same PLMN or in a different PLMN, the UE may initiate a PDU Session Establishment procedure with the same PDU session ID over the other access in order to establish user plane resources for the MA PDU session.

Assuming a UE has established a MA PDU session over two 3GPP access networks either in same PLMN or different PLMN: in a case where the UE prioritizes ATSSS over DualSteer, and the UE at a later point in time registers over a non-3GPP access, either in the same PLMN or in a different PLMN, the UE may release the MA PDU session from one of the 3GPP access and initiate a PDU Session Establishment procedure with the same PDU session ID over the non-3GPP access in order to establish user plane resources for the MA PDU session; and a case where the UE prioritizes DualSteer over ATSSS, but loses connectivity to one of the 3GPP access, and is registered over non-3GPP access (prior or after losing the connectivity to one of the 3GPP access), either in the same PLMN or in a different PLMN, the UE may initiate a PDU Session Establishment procedure with the same PDU session ID over the non-3GPP access in order to establish user plane resources for the MA PDU session.

If the UE performs the initial registration on the non-3GPP access, and when the UE at a later point in time registers over one of the 3GPP access either in the same PLMN or in a different PLMN, the UE shall initiate a PDU Session Establishment procedure with the same PDU session ID over one of the 3GPP access in order to establish user plane resources for the MA PDU session.

Assuming a UE has established a MA PDU session over one 3GPP access and one non-3GPP access either in same PLMN or different PLMN: in a case where the UE prioritizes DualSteer over ATSSS, and when the UE at a later point in time registers over another 3GPP access, either in the same PLMN or in a different PLMN, the UE may release the MA PDU session from the non-3GPP access and initiate a PDU Session Establishment procedure with the same PDU session ID over the other 3GPP access in order to establish user plane resources for the MA PDU session; and in a case where the UE prioritizes ATSSS over DualSteer, but loses connectivity to the non-3GPP access, and is registered over another 3GPP access (prior or after losing the connectivity to the non-3GPP access), either in the same PLMN or in a different PLMN, the UE may initiate a PDU Session Establishment procedure with the same PDU session ID over the other 3GPP access in order to establish user plane resources for the MA PDU session.

It is noted that the DualSteer container information element is a new information element to transfer parameters associated with DualSteer. The ATSSS container information element defined for ATSSS may be re-used for carrying the DualSteer parameters.

Described herein are session management procedures for transitioning from the use of two 3GPP access networks for traffic steering and switching to the use of a 3GPP access network and a non-3GPP access network for traffic steering, switching and splitting and vice versa. The solutions leverage the multi-access (MA) PDU session, currently defined for ATSSS, as a PDU session that provides a PDU connectivity service, which can use one access network at a time, or simultaneously one 3GPP access network and one non-3GPP access network. The MA PDU session is extended to a PDU session that provides a PDU connectivity service, which can use one access network at a time, or simultaneously one 3GPP access network and one non-3GPP access network or simultaneously two 3GPP access networks.

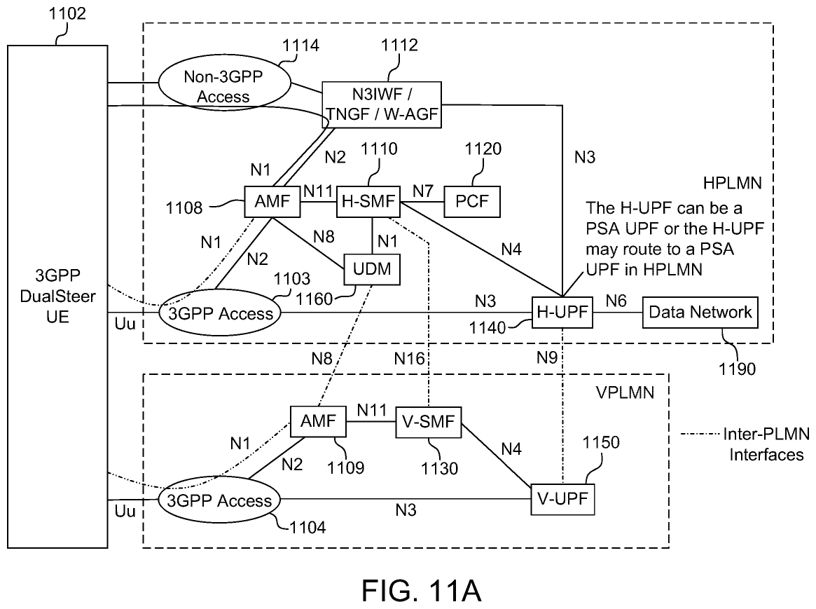

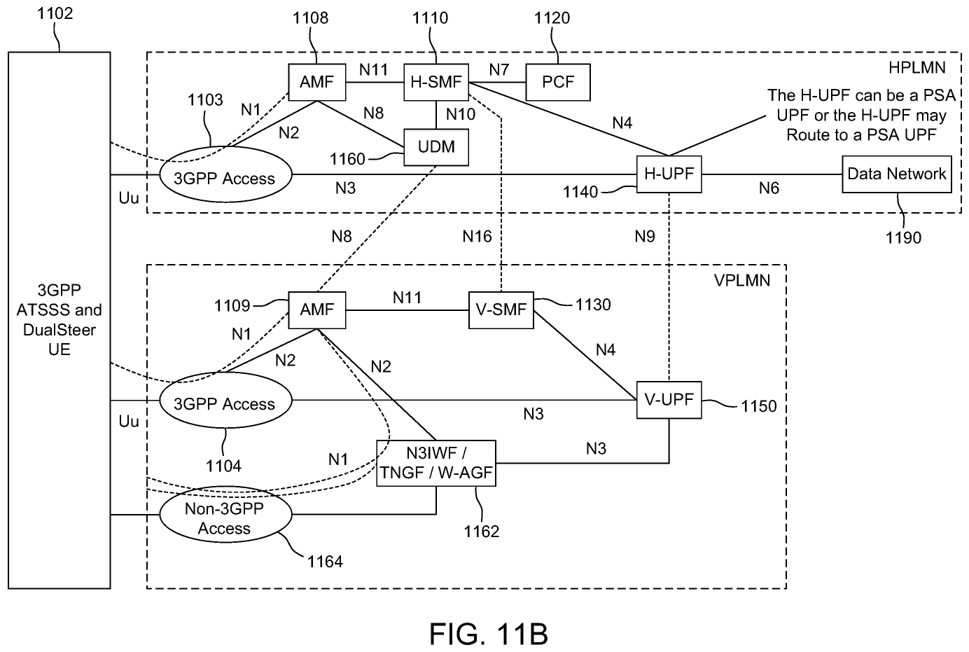

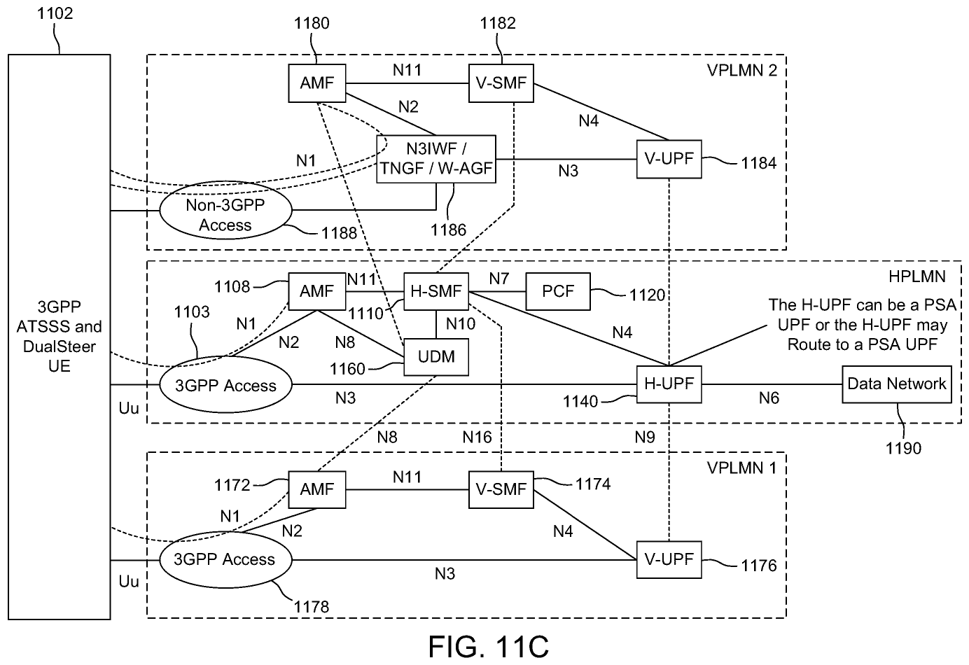

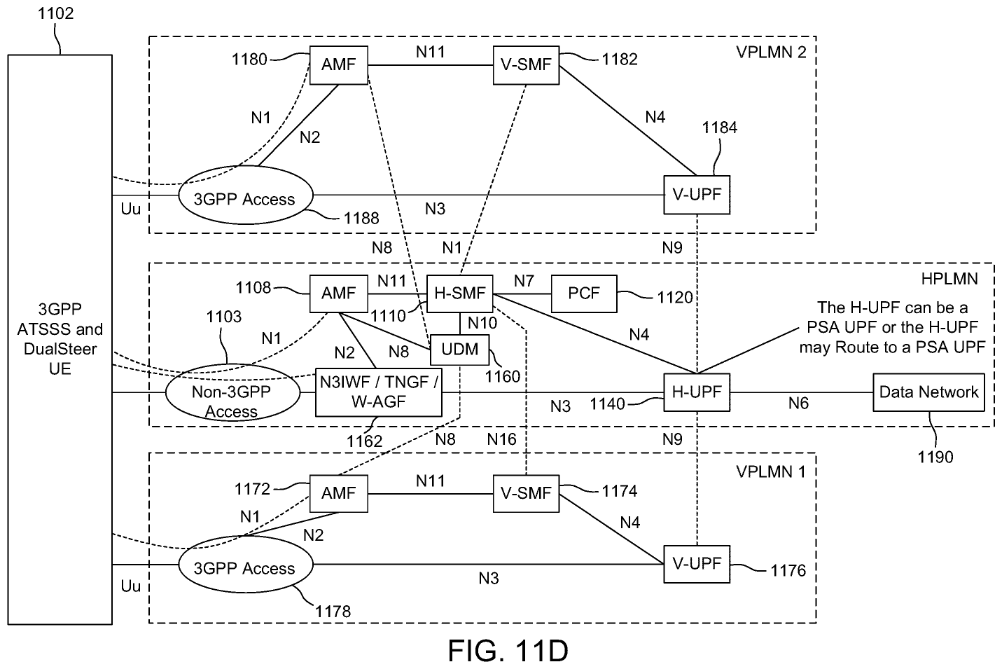

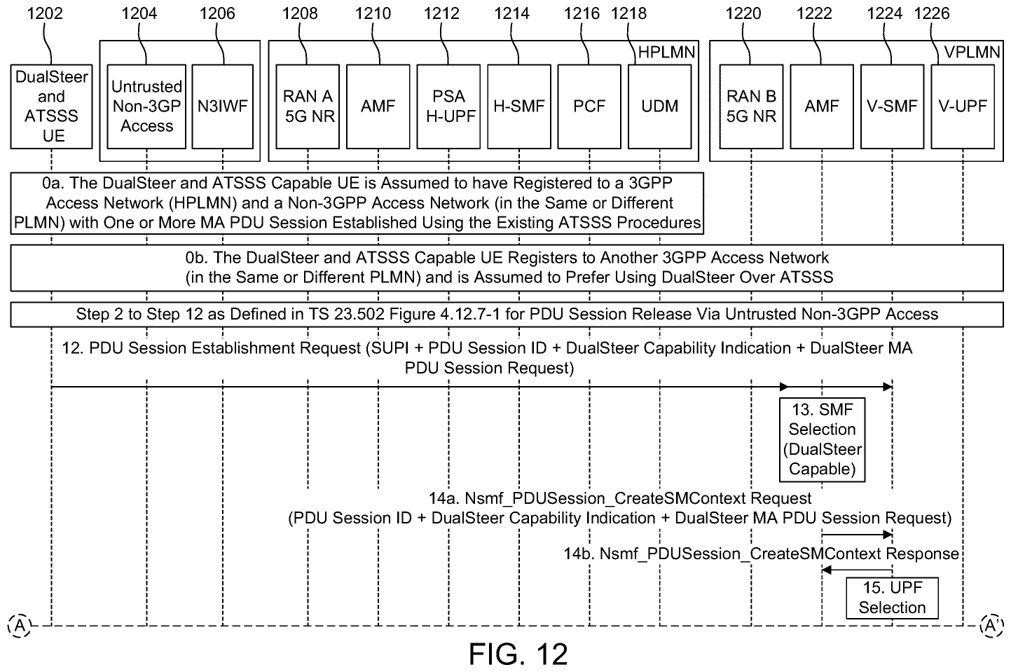

FIG. 11A illustrates an example of an architecture for a communication system for a MA PDU session across a non-3GPP access and 3GPP access in the same PLMN. 3GPP access may also be available. In the example architecture switching between 3GPP access in the HPLMN and VPLMN and non-3GPP access in the HPLMN may occur.

As shown in an example in FIG. 11A, a 3GPP ATSSS/DualSteer UE 1102 may connect to an HPLMN and a VPLMN. The UE 1102 may access an AMF 1108 and the 3GPP Core, via a Uu link and 3GPP access 1103 in the HPLMN. Additionally or alternatively, the UE 1102 may access an AMF 1109 and the 3GPP Core, via a Uu link and 3GPP access 1104 in the VPLMN.

The UE may connect to the 5GC through the non-3GPP access 1114 via the W-AGF 1112 in the W-5GAN. In the HPLMN, UE 1102 may also access the AMF 1108 via an N1 link. Further, the AMF 1108 may connect with 3GPP access 1103 via an N2 link. Additionally, the AMF 1108 may connect with a home-SMF (H-SMF) 1110 via an N1 link. Also, the AMF 1108 may connect with a UDM 1160 via an N8 link. In addition, the H-SMF 1110 may connect with the UDM 1160 via an N1 link. Further, the H-SMF 1110 may connect with a policy control function (PCF) 1120 via an N7 link.

Moreover, the H-SMF 1110 may connect with a home-UPF (H-UPF) 1140 via an N4 link. The H-UPF 1140 may be a PSA UPF, or the H-UPF 1140 may route to a PSA UPF in the HPLMN. In an example, H-UPF 1140 may connect with visited-UPF (V-UPF) 1150 via an N9 link, which may be an inter-PLMN interface.

Further, the UE 1102 may access a data network 1190 using the H-UPF 1140 and an N6 link, via either the various connectivity described above to reach the H-UPF 1140, or via 3GPP Access 1103 connected to the H-UPF 1140 via an N3 link.

Also, the UDM 1160 in the HPLMN may connect with the AMF 1109 in the VPLMN via an N8 link, which may be an inter-PLMN interface. Moreover, the H-SMF 1110 may connect with a visited-SMF (V-SMF) 1130 via an N16 link, which may be an inter-PLMN interface.

In the VPLMN, the UE 1102 may also access the AMF 1109 via an N1 link. Further, the AMF 1109 may connect with 3GPP access 1104 via an N2 link. Additionally, the AMF 1109 may connect with the V-SMF 1130 via an N1 link. As noted above, the AMF 1109 may connect with a UDM 1160 via an N8 link. Moreover, the UE 1102 may also access the V-UPF 1150 via 3GPP access 1104, which is connected to the V-UPF 1150 by an N3 link. For brevity, certain connection between elements previously described may not be omitted in describing variations in example architectures.

FIG. 11B illustrates an example of an architecture for a communication system for a MA PDU session across a non-3GPP access and 3GPP access in the same VPLMN. 3GPP access may also be available in the PLMN. In the example architecture of FIG. 11B switching between 3GPP access in the HPLMN and VPLMN and non-3GPP access in the VPLMN may occur. The architecture of the HPLMN in FIG. 11B is similar to the HPLMN of FIG. 11A, but does not include non-3GPP access 1112 nor W-AGF 1114. For brevity, certain connection between elements previously described may not be repeated unless necessary.

As shown in an example in FIG. 11B, UE 1102 may connect to an HPLMN and a VPLMN. The UE 1102 may access an AMF 1109 and the 3GPP Core, via a Uu link and 3GPP access 1104 in the VPLMN. Additionally or alternatively, the UE 1102 may access an AMF 1108 and the 3GPP Core, via a Uu link and 3GPP access 1103 in the HPLMN.

In the VPLMN, UE 1102 may connect to the 5GC through the non-3GPP access 1164 via the W-AGF 1162 in the W-5GAN. W-AGF 1162 may connect with AMF 1109 via N2 link. In an example, H-UPF 1140 may connect with visited-UPF (V-UPF) 1150 via an N9 link, which may be an inter-PLMN interface.

FIG. 11C illustrates an example of an architecture for a communication system for a MA PDU session across a 3GPP in a HPLMN, 3GPP access in a first VPLM, and a non-3GPP access in a second VPLMN. In the example architecture switching may occur between 3GPP access in the HPLMN, 3GPP access in the first VPLMN, and non-3GPP access in the second VPLMN. The architecture of the HPLMN is similar to the HPLMN of FIG. 11B.

As shown in an example in FIG. 11C, a UE 1102 may connect to an HPLMN, a first VPLMN and a second VPLMN. The UE 1102 may access an AMF 1108 and the 3GPP Core, via a Uu link and 3GPP access 1103 in the HPLMN. AMF 1108 may connect with H-SMF 1110 via an N1 link and may connect with a UDM 1160 via an N8 link. In addition, the H-SMF 1110 may connect with the UDM 1160 via an N1 link. Further, the H-SMF 1110 may connect with a policy control function (PCF) 1120 via an N7 link.

UE 1102 may connect to VPLMN1. The UE 1102 may access an AMF 1172 and the 3GPP Core, via a Uu link and 3GPP access 1103 in the HPLMN. AMF 1172 may connect with V-SMF 1174 via an N11 link and may connect with a UDM 1160 via an N8 link. In addition, the H-SMF 1110 may connect with the UDM 1160 via an N1 link.

In the VPLMN2, UE 1102 may connect to the 5GC through the non-3GPP access 1188 via the W-AGF 1186 in the W-5GAN. W-AGF 1186 may connect with AMF 1180 via a N2 link and with V-SMF 1182 via an N11 link. V-SMF 1182 may connect with V-UPF 1184 via and N4 link, and V-UPF 1184 may connect with H-UPF 1140 via an N9 link.

FIG. 11D illustrates an example of an architecture for a communication system for a MA PDU session across a 3GPP in a HPLMN and non-3GPP access in the HPLMN, 3GPP access in a first VPLM, and a 3GPP access in a second VPLMN.

In this example architecture switching may occur between 3GPP access in the HPLMN, 3GPP access in VPLMN1, 3GPP access in VPLMN2, and non-3GPP access in the HPLMN, 3GPP access in the first VPLMN, and non-3GPP access in the second VPLMN. The architecture of the HPLMN is similar to the HPLMN of FIG. 11A. The architecture of VPLMN1 is similar to the architecture in FIG. 11C. In FIG. 11D, VPLMN2 includes 3GPP access and does not include non-3GPP access.

As shown in an example in FIG. 11D, a UE 1102 may connect to an HPLMN, a first VPLMN and a second VPLMN. The UE 1102 may access an AMF 1108 and the 3GPP Core, via a Uu link and 3GPP access 1103 in the HPLMN. AMF 1108 may connect with H-SMF1110 via an N1 link and may connect with a UDM 1160 via an N8 link. In addition, the H-SMF 1110 may connect with the UDM 1160 via an N10 link. Further, the H-SMF 1110 may connect with a policy control function (PCF) 1120 via an N7 link.

The UE may connect to the 5GC through the non-3GPP access 1114 via the W-AGF 1112 in the W-5GAN. In the HPLMN, the UE 1102 may also access the AMF 1108 via an N1 link. Further, the AMF 1108 may connect with 3GPP access 1103 via an N2 link. Additionally, the AMF 1108 may connect with a home-SMF (H-SMF) 1110 via an N1 link. Also, the AMF 1108 may connect with a UDM 1160 via an N8 link. In addition, the H-SMF 1110 may connect with the UDM 1160 via an N10 link. Further, the H-SMF 1110 may connect with a policy control function (PCF) 1120 via an N7 link.

AMF 1172 in VPLMN1 may connect with UDM 1160 via an N8 link, and AMF 1180 in VPLMN2 may connect with UDM 1160 via an N8 link. H-SMF 1110 may connect with V-SMF 1182 in VPLMN2 via a N3 Link, and H-SMF 1110 may connect with V-SMF 1174 in VPLMN1 V-SMF via a N16 Link.

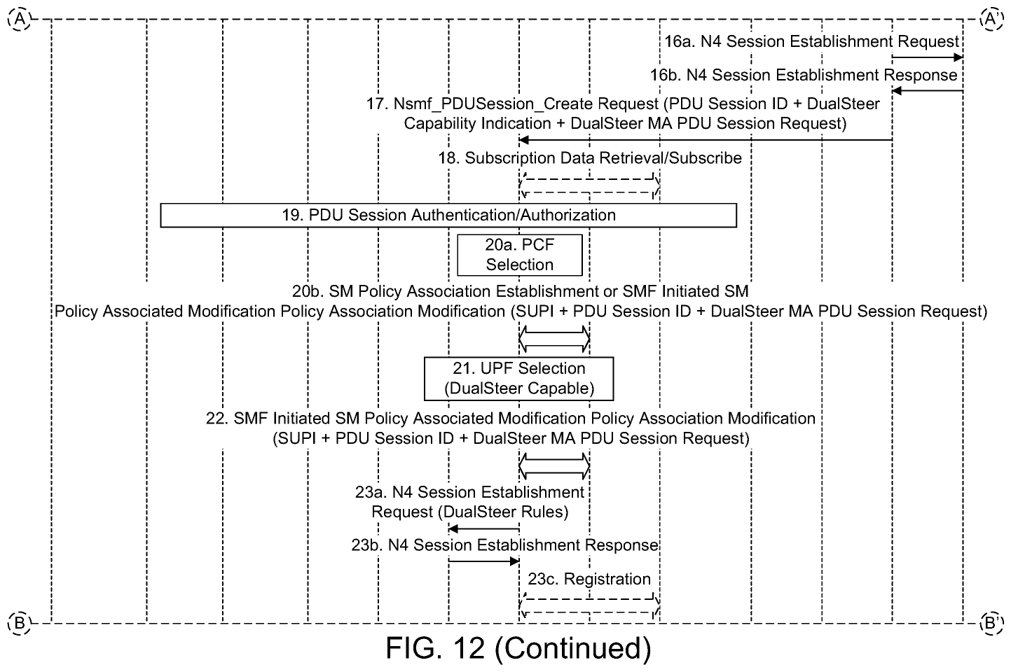

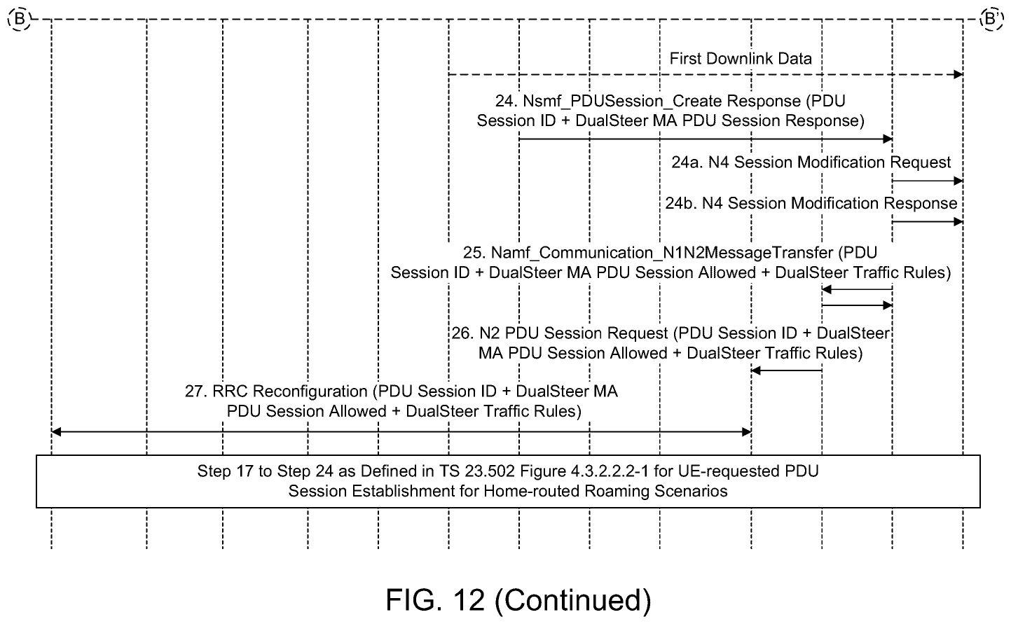

FIG. 12 illustrates an example MA PDU session management procedure. The procedure applies to switching from non-3GPP access/3GPP access (ATSSS) to 3GPP access/3GPP access (DualSteer). It is assumed that UE 1202 supports both features.

As shown in the example process, a ATSSS/DualSteer UE 1202 may access two 3GPP access networks using different PLMNs, for example a HPLMN and a VPLMN or 3GPP network and a non-3GPP access network; the non-3GPP access network contained in one of the two 3GPP access or a third network.

As illustrated in FIG. 12, the non-3GPP access includes access radio 1204 and N3IWF/TNGF/W-AGF 1206; the HPLMN includes a RAN A 5G NR node 1208, an AMF 1210, a PSA H-UPF 1212, an H-SMF 1214, a PCF 1216 and a UDM 1218; and the VPLMN includes a RAN B 5G NR node 1220, an AMF 1222, a V-SMF 1224 and a V-UPF 1226.

The example procedure in FIG. 12 assumes UE 1202 is registered to a 3GPP access network (HPLMN) and a non-3GPP access network with one or more MA PDU sessions established. The non-3GPP access network may be in the same PLMN as the 3GPP access or a different PLMN.

Non-3GPP access includes access radio 1204 may be, for example, an untrusted non-3GPP access with N3IWF in non-roaming or roaming with local breakout architecture. Similar procedures will be followed when using trusted non-3GPP access and wireline access trusted with TNGF and W-AGF respectively and for home-routed architecture when the UE is registered to the same or different VPLMN on the non-3GPP access.

At 0a, UE 1202 is assumed to have registered with a 3GPP access and a non-3GPP access (in the same or different PLMN) with one or more MA PDU Sessions established for the UE using the procedure described in TS 24.193 clause 5.2.1.

At 0b, UE 1202 registers with another 3GPP access (in the same or different PLMN of the previously registered 3GPP access), and prefers DualSteer over ATSSS. The steering preference may be an operator controlled preference.

Steps 1-11 are for UE or network requested MA PDU Session Release following the procedures defined in TS 23.502 clause 4.22.10.2 (non-roaming and roaming with local breakout) and clause 4.22.10.3 (home-routed roaming) for release the user-plane resources on the non-3GPP access network.

In a case where any traffic is being split across both 3GPP and non-3GPP access, after the user plane resources on the non-3GPP access are released, the UE will steer the SDFs (previously switched across 3GP and non-3GPP access) only on the available 3GPP access.

Steps 12-35 are for UE requested PDU session establishment procedure on the VPLMN and may be as defined in TS 23.502 clause 4.3.2.2.2 (steps 22 to 45). The explanation that follows describes aspects of the process implemented to enable switching between ATSSS and DualSteer.

A UE operating in DualSteer will include the PDU Session ID and the DualSteer request within the PDU Session Establishment Request and the CreateSMcontext Request message (indicating the support for DualSteer feature and DualSteer steering functionality/modes) to AMF 1210 in steps 12 and H-SMF 1214 in step 17 (via V-SMF 1224 in step 14a).

If H-SMF 1214 and V-SMF 1224 support DualSteer features include the PDU Session ID and the DualSteer response are included (indicating the support for DualSteer feature and the configured DualSteer rules) to UE 1202 via AMF 1222 in Step 14b.

H-SMF 1214 may perform an SM Policy Association Establishment procedure to establish an SM Policy Association with PCF 1216 in home network and get the default PCC Rules for the PDU Session. This association will consider the DualSteer feature support and any associated polices in step 22.

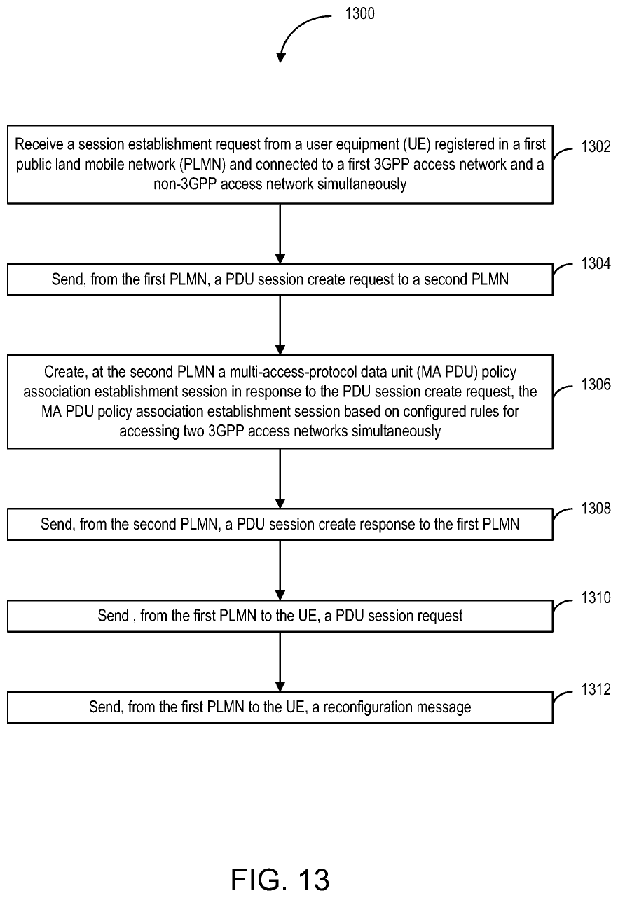

FIG. 13 is flow diagram of an example process 1300 for switching between simultaneous access over a 3GPP access network and non-3GPP access network, and simultaneous access over two 3GPP access networks. In some implementations, one or more process blocks of FIG. 13 may be performed by one or more devices.

As shown in FIG. 13, process 1300 may include receiving a session establishment request from an user equipment (UE) registered in a first public land mobile network (PLMN) and connected to a first 3GPP access network and a non-3GPP access network simultaneously (block 1302). For example, device may receive a session establishment request from an user equipment (UE) registered in a first public land mobile network (PLMN) and connected to a first 3GPP access network and a non-3GPP access network simultaneously, as described above. As also shown in FIG. 13, process 1300 may include sending, from the first PLMN, a PDU session create request to a second PLMN (block 1304). For example, device may send, from the first PLMN, a PDU session create request to a second PLMN, as described above. As further shown in FIG. 13, process 1300 may include creating, at the second PLMN a multi-access-protocol data unit (MA PDU) policy association establishment session in response to the PDU session create request, the MA PDU policy association establishment session based on configured rules for accessing two 3GPP access networks simultaneously (block 1306). For example, device may create, at the second PLMN a multi-access-protocol data unit (ma PDU) policy association establishment session in response to the PDU session create request, the ma PDU policy association establishment session based on configured rules for accessing two 3GPP access networks simultaneously, as described above. As also shown in FIG. 13, process 1300 may include sending, from the second PLMN, a PDU session create response to the first PLMN (block 1308). For example, device may send, from the second PLMN, a PDU session create response to the first PLMN, as described above. As further shown in FIG. 13, process 1300 may include sending, from the first PLMN to the UE, a PDU session request (block 1310). For example, device may send, from the first PLMN to the UE, a PDU session request, as described above. As also shown in FIG. 13, process 1300 may include sending, from the first PLMN to the UE, a reconfiguration message (block 1312). For example, device may send, from the first PLMN to the UE, a reconfiguration message, as described above.

Process 1300 may include additional implementations, such as any single implementation or any combination of implementations described below and/or in connection with one or more other processes described elsewhere herein. In a first implementation, the session establishment request may include information indicating a request to switch access from the non-3GPP access network to a second 3GPP access network for simultaneous connection with the first 3GPP access network and the second 3GPP access network.

In a second implementation, alone or in combination with the first implementation, the session establishment request is a PDU session establishment request message having a PDU session ID, a DualSteer capability indication, and a DualSteer MA PDU session request.

In a third implementation, alone or in combination with the first and second implementation, the first 3GPP access network and the non-3GPP access network are over the first PLMN.

In a fourth implementation, alone or in combination with one or more of the first through third implementations, the first 3GPP access network is over the first PLMN and the non-3GPP access network is over the second PLMN.

In a fifth implementation, alone or in combination with one or more of the first through fourth implementations, the PDU session create request is a PDU session create message having a PDU session ID, a DualSteer capability indication, and a DualSteer MA PDU session request.

In a sixth implementation, alone or in combination with one or more of the first through fifth implementations, the PDU session create response may include a PDU session ID and a DualSteer MA PDU session response.

In a seventh implementation, alone or in combination with one or more of the first through sixth implementations, the PDU session create request may include a PDU session ID, a DualSteer MA PDU session allowed message, and DualSteer traffic rules.

In an eighth implementation, alone or in combination with one or more of the first through seventh implementations, the reconfiguration message is a radio resource control (RRC) reconfiguration message, and where the RRC reconfiguration message may include the PDU session ID, the DualSteer MA PDU session allowed message, and the DualSteer traffic rules.

In a ninth implementation, alone or in combination with one or more of the first through eighth implementations, the first 3GPP access network is over one of the first PLMN or the second PLMN, the non-3GPP access network is over a different one of the first PLMN or the second PLMN, and the session establishment request may include information indicating a request to switch access from over the non-3GPP access network to a second a 3GPP access network over a third PLMN for simultaneous connection with the first 3GPP access network.

Although FIG. 13 shows example blocks of process 1300, in some implementations, process 1300 may include additional blocks, fewer blocks, different blocks, or differently arranged blocks than those depicted in FIG. 13. Additionally, or alternatively, two or more of the blocks of process 1300 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless communication system comprising:
a first public land mobile network (PLMN); and
a second PLMN;
the first PLMN configured to:
receive a session establishment request from a user equipment (UE) connected to a first 3GPP access network and a non-3GPP access network simultaneously; and
send a PDU session create request to the second PLMN;
the second PLMN configured to:
create a multi-access-protocol data unit (MA PDU) policy association establishment session in response to the PDU session create request, the MA PDU policy association establishment session based on configured rules for accessing two 3GPP access networks simultaneously; and
send a PDU session create response to the first PLMN; and
the first PLMN configured to:
send a PDU session request to the UE; and
send a reconfiguration message to the UE.

2. The wireless communication system of claim 1, wherein the session establishment request comprises information indicating a request to switch access from the non-3GPP access network to a second 3GPP access network for simultaneous connection with the first 3GPP access network and with the second 3GPP access network.

3. The wireless communication system of claim 2, wherein the session establishment request is a PDU session establishment request message comprising a PDU session ID, a DualSteer capability indication, and a DualSteer MA PDU session request.

4. The wireless communication system of claim 1, wherein the PDU session create request is a PDU session create message comprising a PDU session ID, a DualSteer capability indication, and a DualSteer MA PDU session request.

5. The wireless communication system of claim 1, wherein the PDU session create response comprises a PDU session ID and a DualSteer MA PDU session response.

6. The wireless communication system of claim 1, wherein the PDU session create request comprises a PDU session ID, a DualSteer MA PDU session allowed message, and DualSteer traffic rules.

7. The wireless communication system of claim 6, wherein the reconfiguration message is a radio resource control (RRC) reconfiguration message, and wherein the RRC reconfiguration message comprises the PDU session ID, the DualSteer MA PDU session allowed message, and the DualSteer traffic rules.

8. The wireless communication system of claim 2, wherein the first 3GPP access network and the non-3GPP access network are over the first PLMN, and the second 3GPP access network is over a second PLMN.

9. The wireless communication system of claim 2, wherein the first 3GPP access network is over the first PLMN, the non-3GPP access network is over the second PLMN, and the second 3GPP access network is a second PLMN.

10. The wireless communication system of claim 1, wherein the first 3GPP access network is over one of the first PLMN or the second PLMN, the non-3GPP access network is over a different one of the first PLMN or the second PLMN, and the session establishment request comprises information indicating a request to switch access from over the non-3GPP access network to a second 3GPP access network over a third PLMN for simultaneous connection with the first 3GPP access network.

11. A method performed in a wireless communication system, the method comprising:
receiving a session establishment request from a user equipment (UE) registered in a first public land mobile network (PLMN) and connected to a first 3GPP access network and a non-3GPP access network simultaneously;
sending, from the first PLMN, a PDU session create request to a second PLMN;
creating, at the second PLMN a multi-access-protocol data unit (MA PDU) policy association establishment session in response to the PDU session create request, the MA PDU policy association establishment session based on configured rules for accessing two 3GPP access networks simultaneously;
sending, from the second PLMN, a PDU session create response to the first PLMN;
sending, from the first PLMN to the UE, a PDU session request; and
sending, from the first PLMN to the UE, a reconfiguration message.

12. The method of claim 11, wherein the session establishment request comprises information indicating a request to switch access from the non-3GPP access network to a second 3GPP access network for simultaneous connection with the first 3GPP access network and the second 3GPP access network.

13. The method of claim 12, wherein the session establishment request is a PDU session establishment request message comprising a PDU session ID, a DualSteer capability indication, and a DualSteer MA PDU session request.

14. The method of claim 11, wherein the PDU session create request is a PDU session create message comprising a PDU session ID, a DualSteer capability indication, and a DualSteer MA PDU session request.

15. The method of claim 11, wherein the PDU session create response comprises a PDU session ID and a DualSteer MA PDU session response.

16. The method of claim 11, wherein the PDU session create request comprises a PDU session ID, a DualSteer MA PDU session allowed message, and DualSteer traffic rules.

17. The method of claim 16, wherein the reconfiguration message is a radio resource control (RRC) reconfiguration message, and wherein the RRC reconfiguration message comprises the PDU session ID, the DualSteer MA PDU session allowed message, and the DualSteer traffic rules.

18. The method of claim 12, wherein the first 3GPP access network and the non-3GPP access network are over the first PLMN.

19. The method of claim 12, wherein the first 3GPP access network is over the first PLMN and the non-3GPP access network is over the second PLMN.

20. The method of claim 11, wherein the first 3GPP access network is over one of the first PLMN or the second PLMN, the non-3GPP access network is over a different one of the first PLMN or the second PLMN, and the session establishment request comprises information indicating a request to switch access from over the non-3GPP access network to a second a 3GPP access network over a third PLMN for simultaneous connection with the first 3GPP access network.
